(19) United States
(12) Patent Application Publication
(10) Pub. No.: US 2012/0085214 A1
(43) Pub. Date: Apr. 12, 2012

(54) LIGHT GUIDE ALIGNMENT DEVICE FOR POWER TOOL

(75) Inventor: Jan S. Koegel, Arlington Heights, IL (US)

(73) Assignees: ROBERT BOSCH GMBH, Stuttgart (DE); ROBERT BOSCH TOOL CORPORATION, Broadview, IL (US)

(21) Appl. No.: 12/900,784

(22) Filed: Oct. 8, 2010

(51) Int. Cl. B23Q 17/24; B23D 59/00; B23D 45/06

(52) U.S. Cl. 83/471; 83/520

(57) ABSTRACT

A power tool with an alignment device includes a circular saw blade which defines a front side and a rear side of the power tool. The power tool further includes a light source and a light guide positioned on the front side of the power tool. The light guide is configured to direct a beam of light from the light source to a position in front of the circular saw blade and provide a kerf indicator for the circular saw blade. In various embodiments, the kerf indicator may be a shaded line or an illuminated line. The light guide may be connected to a blade guard that at least partially covers the circular saw blade. In at least one embodiment, the light guide is provided on the front side of the power tool as an elongated fin substantially aligned with the circular saw blade.

### FIELD

This application relates to the field of power tools and particularly to alignment devices for power tools.

### BACKGROUND

Table saws and other power tools with circular saw blades are configured to cut workpieces of various shapes and sizes. To produce a cut in a workpiece, the user either moves the saw in a straight line into engagement with the workpiece or moves the workpiece in a straight line into engagement with the saw. The user attempts to maintain a proper alignment between the workpiece and the saw to produce the cut in a desired position on the workpiece. Therefore, users of these saws need to visualize where a cut will occur on a workpiece both before and during the time the cut is being made.

In order to assist the user in making a cut at the desired location on a workpiece, some power tools include a light. The light may serve to illuminate the work area and/or provide a kerf indicator showing where the saw blade will cut the workpiece if the saw is moved in a straight line relative to the workpiece.

Kerf indicators have been provided in different ways. One typical arrangement for providing a kerf indicator is a laser light that shines along the side of the blade and produces an illuminated line on a surface in front of the saw. While these arrangements are generally satisfactory, they can sometimes be confusing to the user because the laser light shines to the side of the actual cut location.

Another typical arrangement for providing a visual cut indicator is to mount a light to the rear of the saw blade that casts a shadow of the saw blade along a line in front of the saw. While these arrangements are also satisfactory, they also have some downsides. For example, in high light situations, it may be difficult to see the projected shadow line. Also, the shadow indicator may be somewhat confusing to the user, since the cut indicator is actually a darkened line instead of a bright line.

In view of the foregoing, it would also be advantageous to provide an alignment device offering a clear visual indication of the cut location for a power saw. It would also be advantageous if this indicator provided an illuminated line in the front of the saw extending directly along cut line. It would also be advantageous if the alignment device could be used in various light conditions and offered additional illumination for poor light conditions.

### SUMMARY

In accordance with one embodiment of the disclosure, there is provided a power tool comprising a circular saw blade which defines a front side and a rear side of the power tool. The power tool further comprises a light source and a light guide positioned on the front side of the power tool. The light guide is configured to direct a beam of light from the light source to a position in front of the circular saw blade and provide a kerf indicator for the circular saw blade. In various embodiments, the kerf indicator may be a shaded line or an illuminated line. The light guide may be connected to a blade guard that at least partially covers the circular saw blade. In at least one embodiment, the light guide is provided on the front side of the power tool as an elongated fin substantially aligned with the circular saw blade.

Pursuant to another embodiment of the disclosure, there is provided a power tool comprising a saw with a circular saw blade and a table that supports the saw. The table includes a table top with a first table portion in front of the saw blade and a second table portion behind the saw blade. A light guide extends at least partially over the first table portion in front of the saw blade. The light guide is configured to receive light from a light source and direct a beam of light toward the table top in order to provide a kerf indicator for the saw. In at least one embodiment, the light guide comprises an elongated fin-shaped member substantially aligned with the circular saw blade. The elongated fin-shaped member may be removably coupled to the table or coupled to a blade guard on the saw.

The above described features and advantages, as well as others, will become more readily apparent to those of ordinary skill in the art by reference to the following detailed description and accompanying drawings. While it would be desirable to provide an alignment device for a power tool that provides one or more of the foregoing or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a perspective view of a table saw with a light guide alignment device;

FIG. 2 shows a top view of the table saw of FIG. 1;

FIG. 3 shows a cutaway side view of the table saw of FIG. 1;

FIG. 4 shows a perspective view of an alternative embodiment of the table saw with light alignment device;

FIG. 5 shows a top view of the table saw of FIG. 4;

FIG. 6 shows a cutaway side view of the table saw of FIG. 4;

FIG. 7 shows a cutaway front view of a light guide for the table saw of FIG. 4;

FIG. 8 shows a perspective view of another alternative embodiment of the table saw with light alignment device of FIG. 1;

FIG. 9 shows a perspective view of an alternative embodiment of a table saw with a light guide alignment device used in association with a self-closing guard;

FIG. 10 shows an enlarged perspective view of the light alignment device and self-closing guard of FIG. 9;

FIG. 11 shows a perspective view of an alternative embodiment of the table saw with a light guide alignment device and self closing guard of FIG. 9;

FIG. 12 shows an enlarged view of the table saw tithe light guide alignment device and self closing guard of FIG. 11; and

FIG. 13 shows an perspective view of yet another alternative embodiment of the table saw with a light guide alignment device and self closing guard of FIG. 9.

### DESCRIPTION

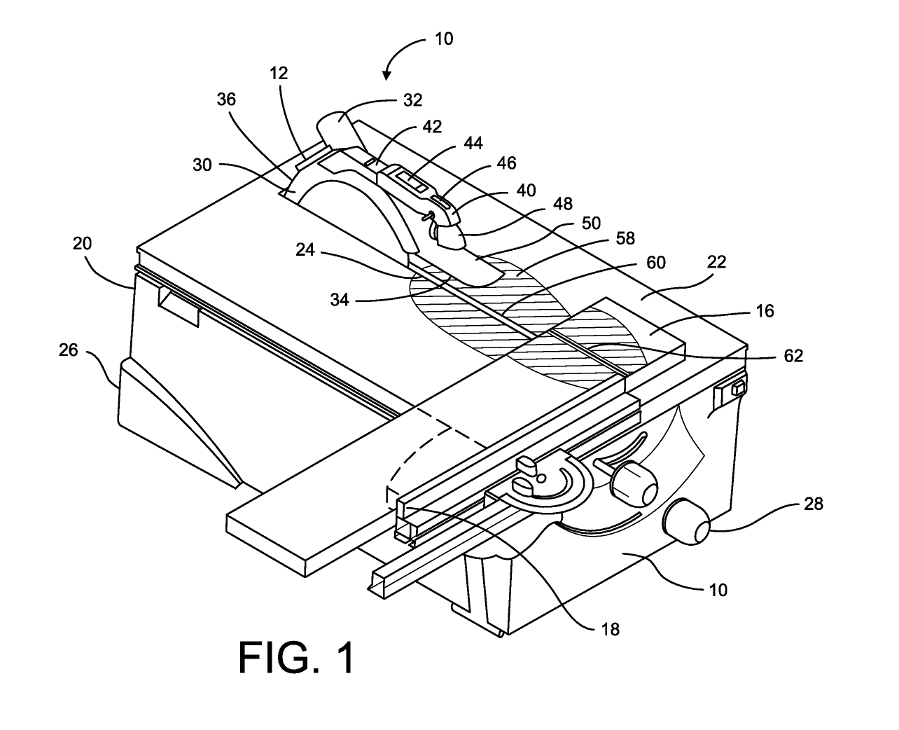

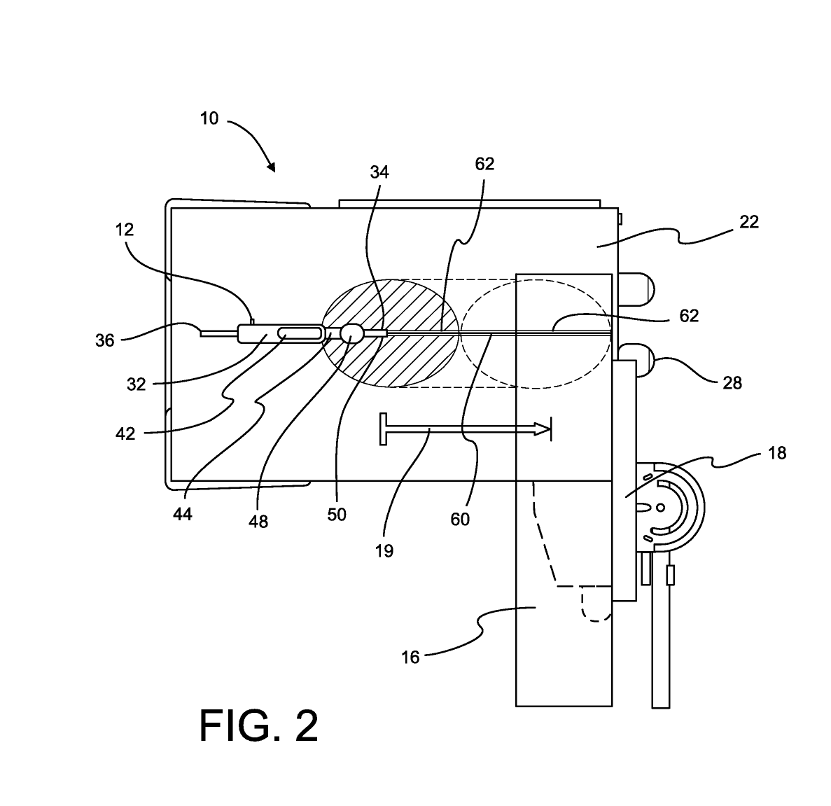

With general reference to FIGS. 1-3, an embodiment of a power tool with a light guide alignment device is shown. The power tool is shown in the form of a table saw 10 comprising a saw 12 with a circular saw blade 14. An alignment assembly 40 with a light guide 50 is mounted to the front side of the saw 12. The light guide 50 is configured to direct a beam of light from a light source 48 to a position in front of the circular saw blade and provide a kerf indicator 60 for the circular saw blade.

As will be recognized by those of skill in the art, the table saw 10 may include a moveable carriage (not shown) that is coupled to the underside of the table top 22. The carriage holds the saw 12 with the circular saw blade 14 extending through an opening 24 formed in the table top 22. The opening 46 in the table top 40 is generally provided in the form of an elongated slot, allowing the saw blade 14 to move in a linear direction along the table top 22. The circular saw blade defines a front side 34 and a rear side 36 of the saw 20. A riving knife 30 is positioned on the rear side of the saw and aligned with the circular saw blade 14. The riving knife 30 moves in the linear direction 19 along with the circular saw blade 14. When electrical power is delivered to the saw 12, the circular saw blade 14 rotates, allowing a user to cut a workpiece 16 positioned on the table top 22. A universal fence 18 or other accessory attached to the table may assist the user in holding the workpiece 16 in place. Although the power tool disclosed herein is a table saw, it will be recognized that in other embodiments the power tool may be different than a table saw.

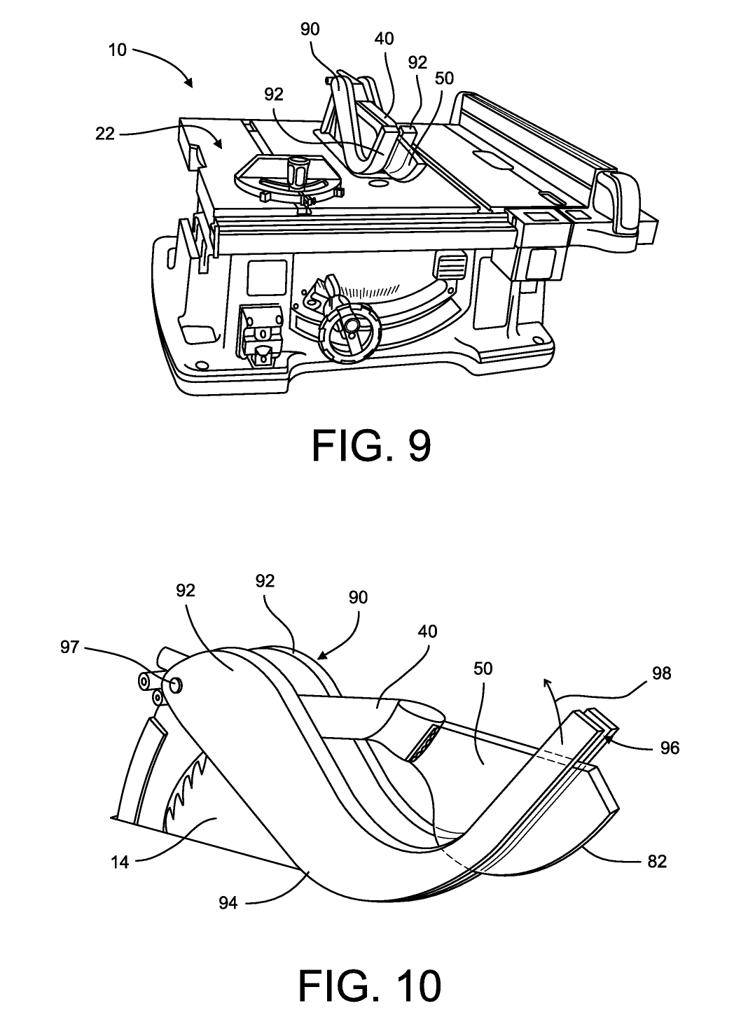

The table top 22 is supported by a table base 26. The table base 26 generally provides a frame structure that holds the table top 22 in an elevated position above the table base 26. The table base 26 may be provided in any of a number of different forms. In the embodiment of FIG. 1, the table base 26 is provided as a housing structure, including four walls. Various table saw controls 28 such as a power switch, pull rod, or bevel adjustment member may be provided on the front wall of the housing. While a table base 26 with walls has been shown in the embodiment of FIG. 1, in other embodiments, the table base may be a frame of metallic support members without walls secured thereto. Although the table saw 10 shown in the embodiment of FIGS. 1-3 is configured for use with a moveable undercarriage, it will be recognized that the table saw may also be a standard table saw that does not include a moveable carriage. An embodiment of such a table saw is discussed in further detail below with reference to FIGS. 9 and 10. Accordingly, it will be recognized that the various embodiments of alignment assemblies 40 and light guides 50 disclosed herein may be used in association with various types of table saws or other power tools.

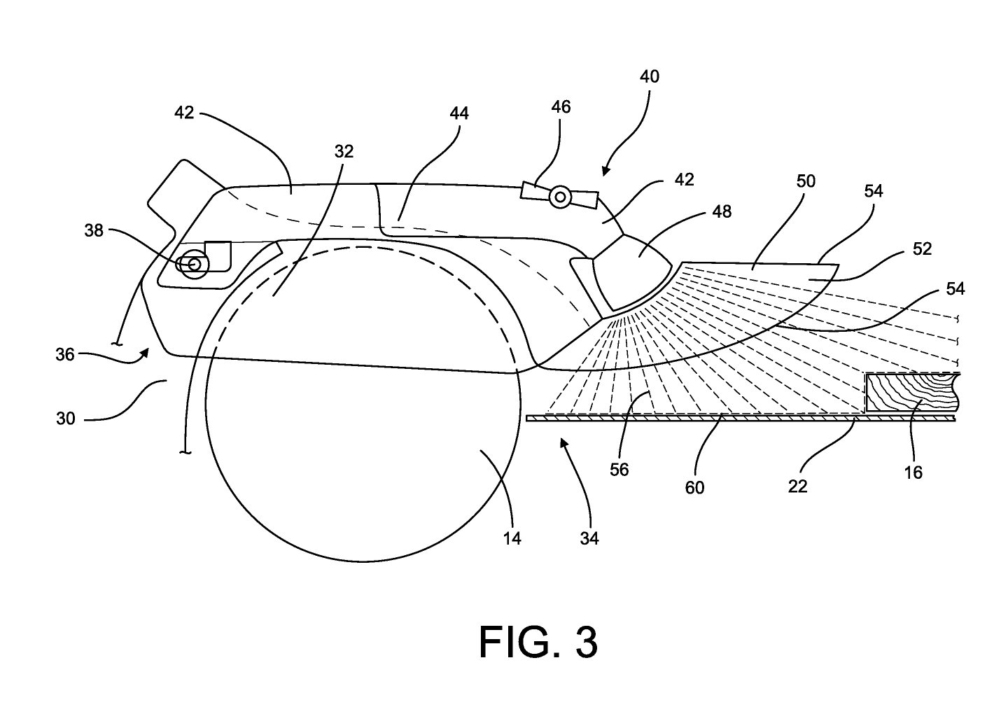

As best seen in FIG. 3, a blade guard 32 covers an upper portion of the circular saw blade 14. The blade guard 32 is pivotably connected to the riving knife 30 at a pivot point 38 on the rear side of the saw. The blade guard 32 generally covers most of the saw blade above the table top 22. The blade guard 32 is positioned above the table top 22 by a clearance distance that allows the blade 14 to cut into a workpiece 16 on the table top 22 as the blade guard passes over the workpiece.

With continued reference to FIG. 3, an alignment assembly 40 is connected to the blade guard 32. The alignment assembly 40 includes a main support housing 42 that is positioned on top of the blade guard 32. The main support housing 42 may be fixed to the blade guard 32 such that it is permanent or removably positioned on the blade guard as an add-on feature.

The main support housing 42 of the alignment assembly 40 includes a battery compartment 44 and a power switch 46. The light source 48 is connected to the front side of the main support housing 42. Batteries positioned in the battery compartment 44 provide power to the light source 48. The power switch 46 is operable to connect or disconnect the light source and the batteries. The light source 48 may be any of various different types of light sources. For example, the light source may comprise an incandescent light source, an LED, or other type of light source. The light source 48 is positioned on the main support housing such that it emits light in a direction generally forward and/or downward from the circular saw blade 14.

The alignment assembly 40 also includes a light guide 50 that is connected to the front portion of the main support housing 42. The light guide 50 is generally an elongated fin-shaped member that extends forward from the main support housing 42 and is aligned with the circular saw blade 14. Accordingly, in the embodiment of FIG. 3, the light guide 50 includes two substantially planar side walls 52 bordered by a perimeter wall 54. The width of the side walls 52 is substantially greater than the thickness of the perimeter wall 54, making the light guide 50 a generally flat and thin elongated member. The perimeter wall 54 extends around the flat parallel sides 52, and defines a general shape for the light guide 50. For example, in the embodiment of FIG. 3, the light guide has a generally fan shaped perimeter with a flat upper edge and a curved lower edge.

The light guide 50 is generally configured to receive light emitted by the light source 48 and direct the light toward the table top in order to provide a kerf indicator for the saw 12. Accordingly, light beams that enter the light guide 50 from the light source 48 are channeled in a within the light guide 50 into a controlled output beam 56. In the embodiment of FIGS. 1-3, the output beam 56 includes a light cone that provides a peripheral surface light 58 and a kerf indicator 60. The peripheral surface light 58 illuminates an area to the sides of the intended cut line. The kerf indicator 60 provides an indication of where the saw blade 14 will cut when the saw 12 is moved in the linear direction. In the embodiment of FIGS. 1-3, the kerf indicator 60 is provided as a shaded line 62 in the middle of the light cone.

The placement of the alignment assembly 40 at the front of the saw 12 allows the output light beam 56 to be directed to a precise location on the table top 22 in front of the saw blade 14. The light at this forward position can be used to provide both the kerf indicator 60 as well as peripheral lighting for the work area. Placement of the light source 48 and light guide 50 at the forward position means that the output beam 56 does not need to travel past either opposing side of the circular saw blade 14. Accordingly, open work space without obstructions exists between the light guide 50 and the desired kerf indicator 60.

The light guide 50 may be provided in any of numerous different embodiments. For example, in one embodiment, the light guide 50 may be provided as an optical waveguide comprised of an optical prism or optical fiber. The material for the optical waveguide may be any of various known materials for producing such optical waveguides, including glass or polymer materials. In other embodiments, the light guide could be a substantially hollow member with a plurality of reflective interior surfaces that direct the light into the desired output beam 56.

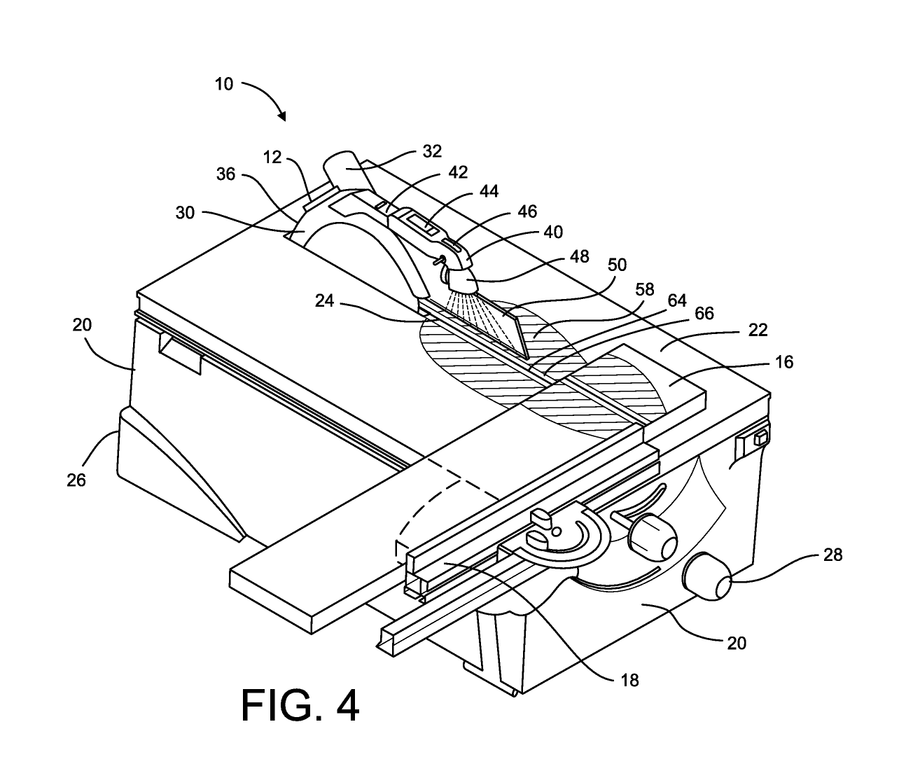

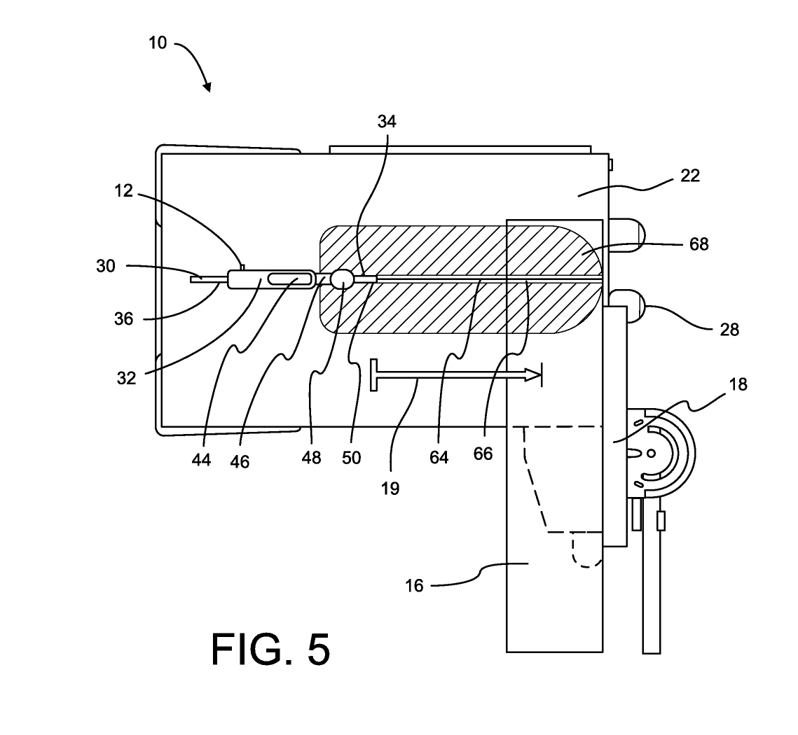

With reference now to FIGS. 4-7, an alternative embodiment of the table saw 10 is shown where the light guide 50 channels the output beam 56 such that the kerf indicator 60 is provided as an illuminated line instead of a shaded line. In this embodiment, the light guide 50 shines an illuminated center line 64 on the table top 22 with elongated shaded areas 66 extending along both sides of the center line 64. The light guide 50 is also configured to provide a peripheral illuminated area 68 along the outer sides of the shaded areas 66.

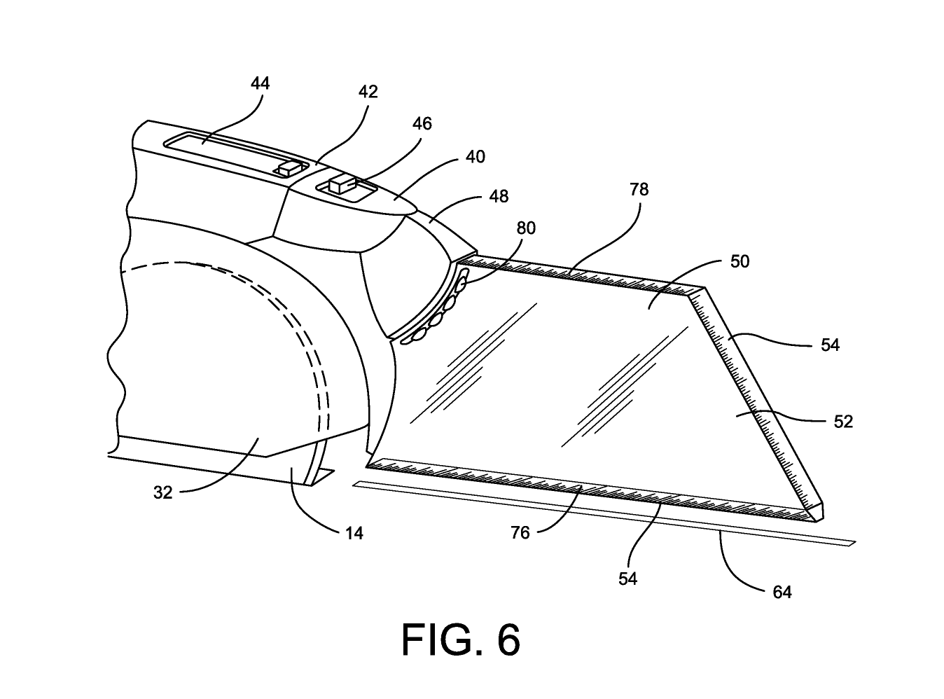

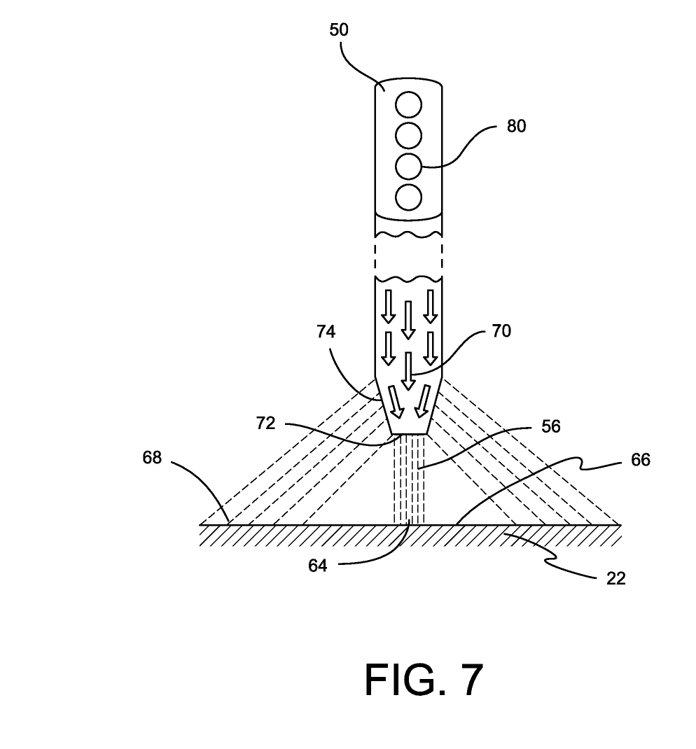

With particular reference to FIGS. 6 and 7, the light guide 50 is provided in a generally trapezoidal shape with the longest edge along the bottom portion 70 of the light guide 50. As shown in FIG. 7, the bottom portion 70 includes a bottom surface 72 and two chamfered edges 74. In this embodiment, the light source 48 is provided by four LEDs 80. Light from the LEDs 80 is channeled through the light guide 50 to the bottom portion 70 of the light guide 50. Light is output from the bottom surface 72 to provide the kerf indicator 60. Some light is also directed out of the chambered edges 74 to provide the peripheral illuminated area 68. Because of the angle between the bottom surface 72 and the chambered edges 74, light is not output to the region between the kerf indicator 60 and the peripheral illuminated area 68, resulting in shaded sides 66.

As shown in the embodiment of FIGS. 6 and 7, upper tick marks 78 and lower tick marks 76 may be provided on the light guide 50. The upper tick marks 78 are positioned along the upper perimeter of the light guide and the lower tick marks 76 are provided along the bottom portion 70 of the light guide 50. The lower tick marks 76 are projected onto the table top 22 by the output beam 56, resulting in small shaded areas along the illuminated center line 64 or along the peripheral illuminated side areas. The projected tick marks provide a scale for the user of the saw. This scale may be useful in various situations, such as when a user wants to cut only a desired length into a workpiece 16.

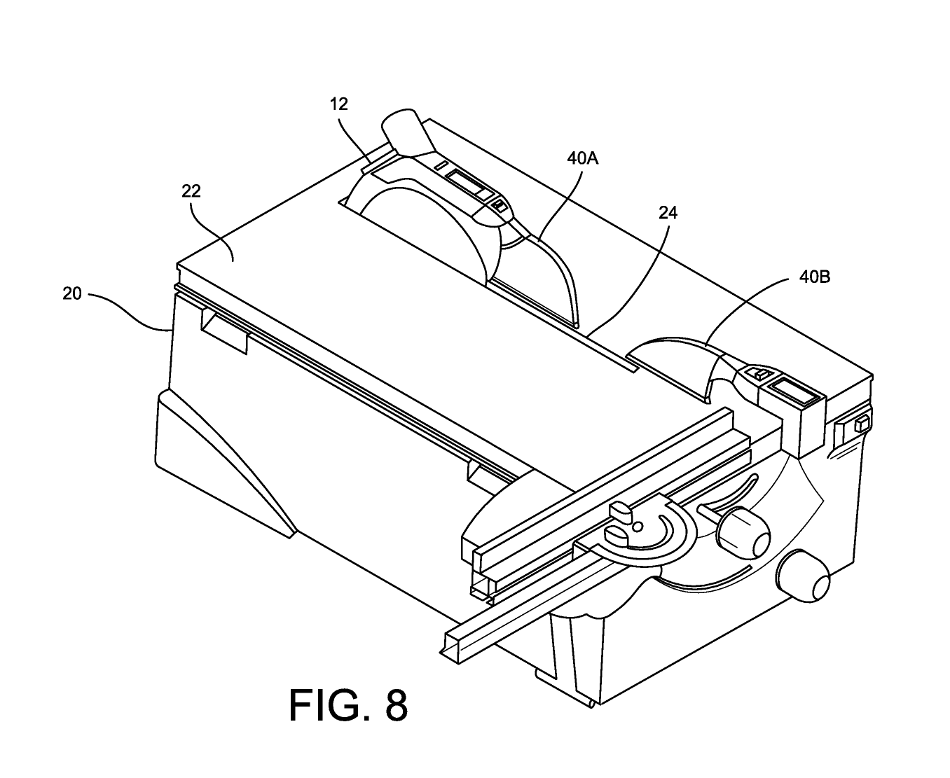

With reference now to FIG. 8, an alternative embodiment of the table saw 10 is shown where two alignment assemblies 40A and 40B are included on the table saw. The first alignment assembly 40A is mounted on the saw 12, as described above in the embodiments of FIGS. 1-3 and 4-7. The second alignment assembly 40B is mounted to the edge of the table 20. This second alignment assembly 40B includes coupling features that allow it to be releasably mounted to complementary coupling features along the side of the table. The second alignment assembly 40B is mounted on the table 20 such that the kerf indicator aligns with the slot 24 on the table. Together, the two alignment assemblies 40A and 40B provide a kerf indicator that is longer than that provided by a single alignment assembly. Although two alignment assemblies 40A and 40B are shown in FIG. 8, it will be recognized that the first alignment assembly 40A could be removed from the saw, leaving the second alignment assembly 40B as the sole alignment assembly for use by the operator of the saw.

With reference now to FIGS. 9 and 10 another alternative embodiment of the table saw 10 with a light alignment device is shown. In this embodiment, the table saw 10 is a standard table saw that does not include a moveable undercarriage. The table saw 10 includes a self-closing upper guard 90. The guard 90 generally provides a top covering for the blade 14 with two parallel arms 92 that are positioned to the sides of the blade 14. Each arm 92 generally includes one end that is positioned above the blade and an opposite end that is positioned forward of the blade 14. Each arm 92 also includes a curved lower surface 94 that extends from one end to the opposite end of the arm 92. A slot 96 is formed between the two arms 92. The guard 90 is configured to pivot with respect to the blade 14 about a pivot point 97. In particular, when a workpiece 16 is moved in a forward direction such that it contacts the curved lower surface 94 of the guard 90, the guard pivots upward as indicated by arrow 98, allowing the workpiece 16 to be moved into engagement with the saw blade 14.

Various embodiments of the alignment assembly 40 with a light guide 50 may be used in association with the self-closing upper guard 90. In the embodiment of FIGS. 9 and 10, the main support 42 of the alignment assembly 40 is positioned above the saw blade 14 between the two arms 92 of the guard 90. The light guide 50 extends through the slot 96 between the arms 92 and past the forward end of the arms 92. The alignment assembly 40 with light guide 50 may be configured as a pivoting member or a stationary member. If the light guide 50 is stationary, the light guide will be positioned a sufficient distance above the table top 22 to allow the workpiece 16 to move under the light guide 50. Alternatively, the light guide 50 may be configured to pivot similar in operation to the upper guard. For example, in the embodiment of FIGS. 9 and 10, the alignment assembly 40 may be configured to pivot about pivot point 97 when a workpiece slideably engages a curved front surface 82 of the light guide 50. In this embodiment, the main support 42 and light guide 50 may be rigidly connected to one another such that both members pivot about the pivot point 97.

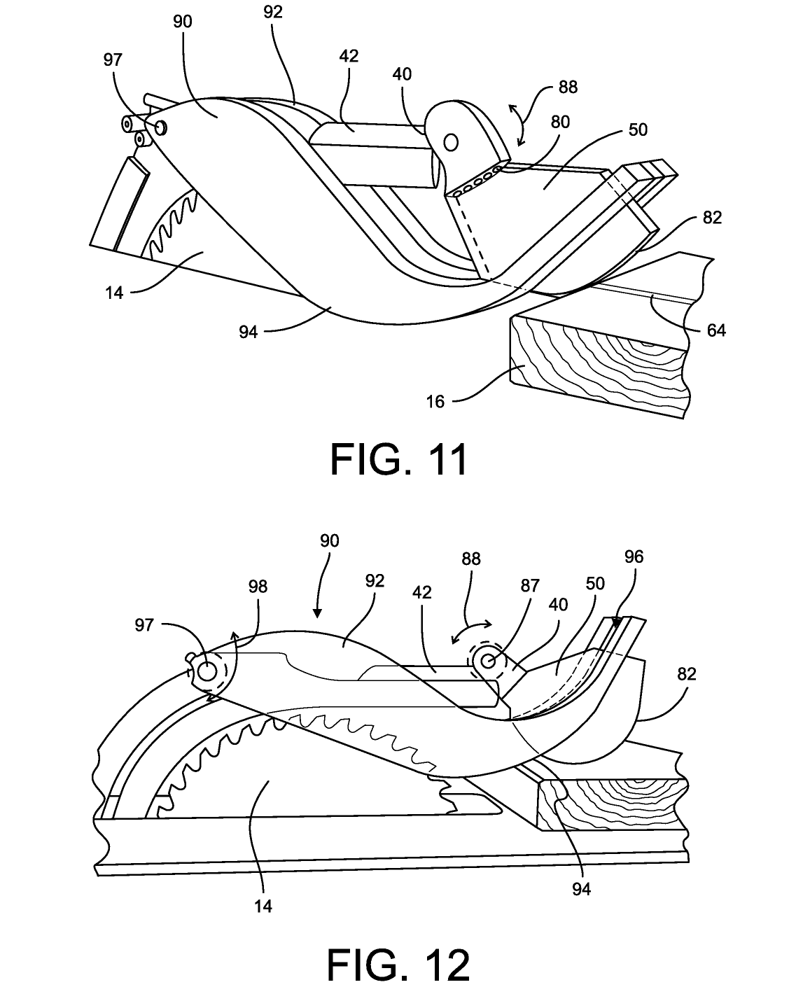

With reference now to FIGS. 11 and 12, an alternative embodiment of the alignment light guide 50 is shown. This embodiment is similar to that of FIGS. 9 and 10, but in this embodiment, the light guide 50 is pivotably connected to the main support 42 of the alignment assembly 40 at pivot point 87. FIG. 11 shows a workpiece 16 that has been moved into engagement with the curved front surface 82 of the light guide 50. As shown in FIG. 12, when the workpiece 16 is moved further toward the saw blade 16 the light guide 50 pivots about pivot point 87, as indicated by arrow 88. The workpiece may then engage the lower surface 92 of the upper guard 90, causing upper guard 90 to pivot about pivot point 97.

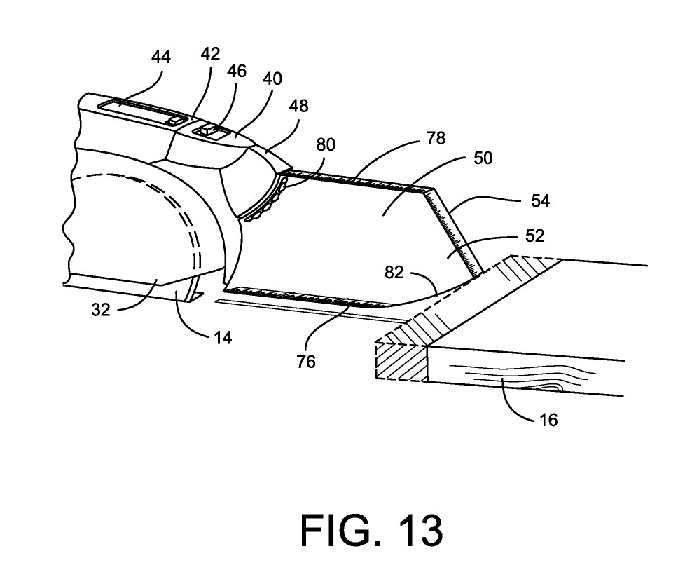

With reference now to FIG. 13, in yet another embodiment the light guide 50 and the main support 42 are rigidly connected to the blade guard 32, and the light guide 50, main support 42, and the blade guard 32 are pivotable with respect to the saw blade 14. Similar to the embodiments of FIGS. 9-12, in the embodiment of FIG. 13, the light guide 50 includes a curved front surface 82 that is configured to engage the work piece 16 when the work piece is moved toward the saw blade 14.

In operation, the various embodiments of the alignment assembly 40 provide the user of a power tool with the option for a light guide alignment device. The user simply switches the power switch 46 on the front of the alignment assembly 40, and light from the light source 48 is channeled through the light guide 50 and directed onto the table to provide a kerf indicator 60. As discussed above, in various embodiments, the kerf indicator 60 may be illuminated or shaded. The light guide 50 may also provide peripheral lighting to the sides of the kerf indicator, thus further illuminating the work area. If the table saw is a stationary saw, the kerf indicator 60 provides an indication of where the saw blade 14 will engage the workpiece 16 as the user moves the workpiece toward the saw blade. Alternatively, if the table saw is a push-pull saw, the kerf indicator 60 moves along with the saw blade 14 and provides an indication of where the saw blade 14 will engage the workpiece 16. After making a desired cut with the saw 12, the user simply flips the power switch 46 to the off position to turn off the light source.

The foregoing detailed description of one or more embodiments of the light guide alignment device has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A power tool comprising:
a circular saw blade, the circular saw blade defining a front side and a rear side of the power tool;
a light source; and
a light guide positioned on the front side of the power tool, the light guide configured to direct a beam of light from the light source to a position in front of the circular saw blade and provide a kerf indicator for the circular saw blade.

2. The power tool of claim 1 wherein the kerf indicator is a shaded line.

3. The power tool of claim 1 wherein the kerf indicator is an illuminated line.

4. The power tool of claim 1 wherein the light guide comprises an optical waveguide.

5. The power tool of claim 1 wherein the light guide comprises at least one reflective surface.

6. The power tool of claim 1 wherein the light guide is connected to a blade guard that at least partially covers the circular saw blade.

7. The power tool of claim 1 wherein the light source comprises at least one LED.

8. The power tool of claim 1 wherein the light source is positioned on the front side of the power tool such that the beam of light does not extend along either opposing side of the circular saw blade.

9. The power tool of claim 1 wherein the light guide includes a plurality of tick marks.

10. The power tool of claim 1 wherein the light guide is provided on the front side of the power tool as an elongated fin substantially aligned with the circular saw blade.

11. A power tool comprising:
a saw with a circular saw blade;
a table supporting the saw, the table including a table top, the table top including a table portion in front of the saw blade and a table portion behind the saw blade;
a light source; and
a light guide extending at least partially over the table portion in front of the saw blade, the light guide configured to receive light from the light source and direct a beam of light toward the table top in order to provide a kerf indicator for the saw.

12. The power tool of claim 11 wherein the light guide comprises an elongated fin-shaped member substantially aligned with the circular saw blade.

13. The power tool of claim 12 wherein the elongated fin-shaped member is removably coupled to the table.

14. The power tool of claim 12 wherein the elongated fin-shaped member is coupled to a blade guard on the saw.

15. The power tool of claim 12 wherein the elongated fin-shaped member comprises an optical prism.

16. The power tool of claim 15 wherein the optical prism includes a center line on a bottom surface, wherein the center line splits the beam of light into opposing sides separated by a shaded line, and the shaded line provides the kerf indicator.

17. The power tool of claim 15 wherein 12 wherein light guide separates the beam of light into an illuminated kerf indicator line with illuminated side areas on opposite sides of the kerf indicator line with shaded areas separating the illuminated kerf indicator from the illuminated side areas.

18. A power tool comprising
a saw blade, the saw blade defining a front side and a rear side of the power tool;
a blade guard at least partially covering the saw blade; and
an elongated light guide oriented substantially parallel to the saw blade, the light guide positioned in front of the blade guard and configured to direct a beam of light from a light source to an area in front of the saw blade in order to provide a kerf indicator for the saw blade.

19. The power tool of claim 18 wherein the elongated light guide is fin-shaped with two substantially parallel sidewalls.

20. The power tool of claim 19 wherein the elongated light guide comprises an optical prism.
